(19) United States
(12) Patent Application Publication
(10) Pub. No.: US 2018/0245617 A1
(43) Pub. Date: Aug. 30, 2018

(54) COUNTING TAPE AND METHOD OF USE WITH A WALL OR FLOOR-MOUNTED STORAGE SYSTEM

(71) Applicant: The Stow Company-Holland, Inc., Holland, MI (US)

(72) Inventors: Aaron J. Hughes, West Olive, MI (US); Bret L. Riedel, Grand Rapids, MI (US); Jonathan J. King, East Grand Rapids, MI (US); Terra M. Kunish, Ravenna, MI (US)

(21) Appl. No.: 15/442,875

(22) Filed: Feb. 27, 2017

(51) Int. Cl. F16B 12/04; G01B 3/10

(52) U.S. Cl. CPC F16B 12/04; G01B 3/1082; G01B 3/1056

(57) ABSTRACT

A counting tape and a method of using the counting tape in assembling a wall or floor-mounted storage system. The counting tape has an elongated body and a plurality of sequentially labeled, non-dimensional, regularly spaced markings on the tape body. The spaced markings correspond to sequentially arranged, regularly spaced holes in the wall or floor-mounted storage system. The counting tape may be supported adjacent the spaced holes and the spaced markings on the counting tape used to uniquely identify an adjacent hole.

### BACKGROUND

The present invention relates to measuring tapes, and more particularly to tapes for use in assembling systems including sequentially arranged, regularly spaced holes.

Wall and floor-mounted storage systems are typically designed to be installed within a closet or other living space in order to facilitate efficient use of the available storage space therein. Wall and floor-mounted storage systems are different from free-standing systems in that they are mounted or anchored to the wall for support and/or safety. Wall and floor-mounted storage systems are generally constructed from individual panels that are assembled on-site and often include options for customization. For example, options are often available that allow a user to customize the type of storage options available within the closet, such as shelving designed for specific items (sweaters, shoes, etc.), sliding drawers or baskets, and rods for supporting items by a hanger, in addition to the relative heights of each of these storage options.

The panels used in constructing wall and floor-mounted storage systems often include a plurality of pre-formed, spaced holes used to assemble the panels and other components of the storage system. The spaced holes are also used to mount the different storage options to the panels, such as shelving and drawers. Hardware, such as pins or screws, are inserted into the spaced holes to connect adjacent panels and to mount other components of the system. For example, a conventional wall or floor-mounted shelving unit includes two vertical panels each having two parallel rows of spaced holes along a length of each vertical panel. Fasteners are inserted into the spaced holes on each vertical panel to mount connecting horizontal top and bottom panels to both vertical panels. Fasteners are also inserted into the spaced holes in both vertical panels to support one or more shelves or other storage option.

It can be challenging to identify which holes in one of the vertical panels aligns with a particular hole in the other vertical panel such that the hardware is all inserted at the same position along the length of both vertical panels. If the fasteners are not at the same position along the length of the vertical panels, the connecting panels and mounted components will not be level. As the length of the vertical panels increases and the number of holes formed along the length thereof increases, it is difficult to simply visually identify a particular hole. Counting each hole to try to identify holes at the same position is time consuming, and it is easy for a user to miscount holes, which can be frustrating.

### SUMMARY

The aforementioned issues are addressed by the present invention in which a counting tape includes a plurality of sequentially labeled, non-dimensional, regularly spaced markings which correspond to sequentially arranged, regularly spaced holes in panels used to assemble a wall or floor-mounted storage system. The counting tape is configured to be supported adjacent one of the panels in a manner which results in the spaced markings on the counting tape aligning with the spaced holes in the panel to facilitate identifying a particular hole in the panel. The counting tape can easily be mounted to each panel of the system or held up by hand adjacent each panel to facilitate identifying a particular hole in each panel and in each row of holes in a single panel.

According to an embodiment of the invention, a counting tape for use in assembling a wall or floor-mounted storage system includes an elongated body having first and second ends. A plurality of sequentially labeled, non-dimensional, regularly spaced markings are included on the tape body. The spaced markings correspond to sequentially arranged, regularly spaced holes in the wall or floor-mounted storage system.

In another embodiment, a method of installing a piece of hardware in a wall or floor-mounted storage system is included. The wall or floor-mounted storage system includes sequentially arranged, regularly spaced holes. The method includes providing a counting tape that has an elongated body with first and second ends. The tape body includes a plurality of sequentially labeled, non-dimensional, regularly spaced markings that correspond to the spaced holes in the wall or floor-mounted storage system. The counting tape is supported adjacent to the wall or floor-mounted storage system by the first end such that the spaced markings on the tape body align with the spaced holes in the wall or floor-mounted storage system. One of the spaced holes is selected, and a piece of hardware is inserted into the selected hole. The spaced markings on the tape body enumerate the spaced holes in the wall or floor-mounted storage system such that a selected one of the spaced holes is identifiable by number.

The embodiments of the invention provide a number of advantages. First, the counting tape is easy to use to quickly identify a particular hole in a panel of a wall or floor-mounted storage system for inserting hardware. Second, the counting tape can easily be moved across a single panel or multiple panels to facilitate quickly identifying holes in different rows on the same panel or on different panels. Third, the counting tape is easy to store and unfurl for use. Fourth, the counting tape is easy to mount and dismount from each panel to facilitate assembly of the wall or floor-mounted storage system. Fifth, the counting tape can be used to quickly identify a particular hole in a panel of a wall or floor-mounted storage system by holding the counting tape aligned with the holes without mounting the counting tape to the system. Sixth, the counting tape can be used during assembly of the wall or floor-mounted storage and/or, in the case of systems with adjustable components, during the lifetime of the system, to adjust the position of different components. All of these improve customer experience and satisfaction.

These and other advantages and features of the invention will be more fully understood and appreciated by reference to the description of the current embodiment and the drawings.

### BRIEF DESCRIPTION OF THE DRAWINGS

FIG. 1 is a perspective view of a storage system according to the prior art.

FIG. 2 is a top-down view of a counting tape according to a first embodiment of the invention for use in assembling the prior art storage system of FIG. 1.

FIG. 3 is a perspective view of a counting tape being mounted to a storage system according to second embodiment of the invention.

FIG. 4 is a perspective view of a counting tape being used to assembly a storage system according to a third embodiment of the invention.

FIG. 5 is a perspective view of a shelf being mounted to a storage system according to an embodiment of the invention.

FIG. 6 is a perspective view of a shelf being mounted to a storage system according to an embodiment of the invention.

FIG. 7 is a schematic illustration of a process of installing a piece of hardware using a counting tape according to a fourth embodiment of the invention.

FIG. 8 is a top-down view of a counting tape according to a fifth embodiment of the invention for use in assembling a storage system.

FIG. 9 is a side view of a counting tape according to a sixth embodiment of the invention for use in assembling a storage system.

FIG. 10 is a perspective view of a counting tape according to seventh embodiment of the invention for use in assembling a storage system.

### DESCRIPTION

### I. Background

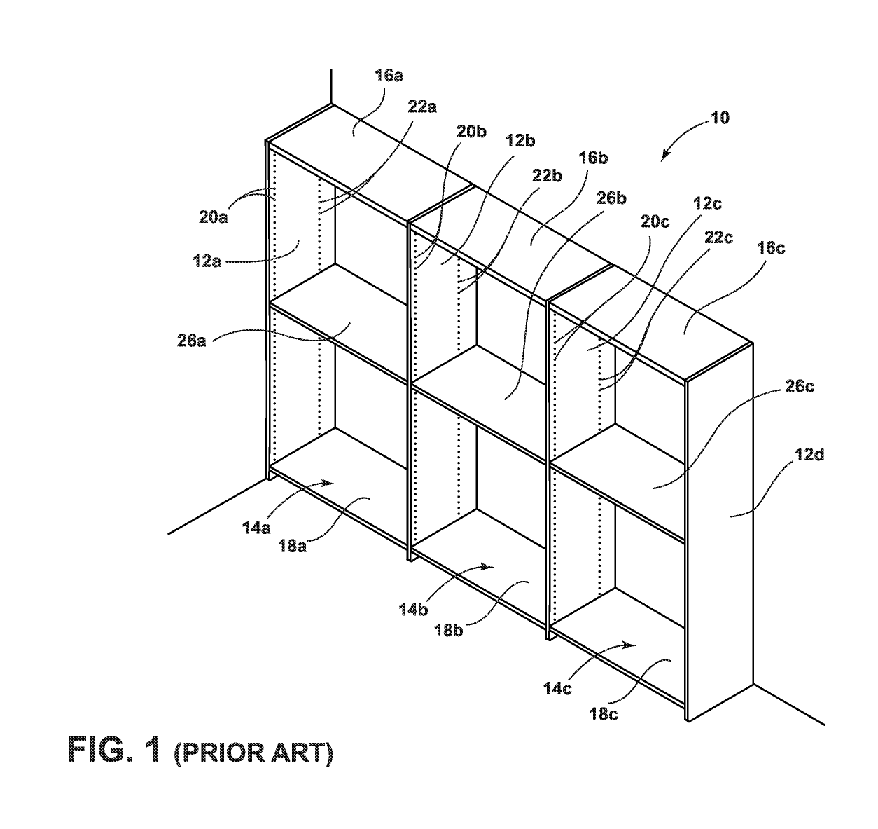

A conventional floor-mounted storage system 10 known in the prior art is illustrated in FIG. 1. The storage system 10 includes a plurality of vertical panels 12a, 12b, 12c, and 12d (also referred to as side panels) for partitioning the storage system 10 into a plurality of separate storage areas 14a, 14b, and 14c. Each vertical panel 12a-d is connected to an adjacent panel 12a-d by upper horizontal panels 16a, 16b, and 16c and lower horizontal panels 18a, 18b, and 18c. Each vertical panel 12a-d includes a first row of sequentially arranged, regularly spaced holes 20a, 20b, 20c, and 20d (not shown) and a second row of sequentially arranged, regularly spaced holes 22a, 22b, 22c, and 22d (not shown).

As used herein, floor-mounted refers to a storage system in which a weight of the vertical panels is at least partially supported on a floor surface. In floor-mounted systems, the system is anchored to an adjacent wall for support and/or safety reasons. The floor-mounted system may be anchored to the wall using an L-bracket or a cleat, for example, or any other anchoring system known in the art. As used herein, wall-mounted refers to a storage system in which a weight of the vertical panels is fully or primarily supported on the wall. Wall-mounted storage systems are mounted to the wall by suspending the components from a track or other hanging device supported on the wall. In some configurations, one or more components of a wall-mounted system may contact the floor surface below. While the embodiments described herein are in the context of a floor-mounted system, it will be understood that the embodiments may also be used with a wall-mounted storage system in a similar manner. In addition, the embodiments described herein may be used with a storage system that includes a combination of floor and wall-mounted sub-systems.

The storage system 10 may include any combination of storage elements, non-limiting examples of which include shelving, sliding drawers or baskets, movable doors, rods for supporting items by a hanger, and hooks. By way of example, storage areas 14a-c each include a shelf 26a, 26b, and 26c. Each shelf 26a-c is mounted to the storage system 10 by hardware (not shown) that is mounted to the vertical panels 12a-d by the rows of regularly spaced holes 20a-d and 22a-d. The hardware may be any type of fastener suitable for mounting a particular component, non-limiting items of which include screws, pins, cam lock fasteners, and barrel nuts.

In one embodiment, the storage system 10 is in the form of a closet partition system. In other embodiments, the storage system 10 is used in any room or enclosure in a residential or business setting. The storage system 10 may include any number of panels and storage elements in various configurations and sizes, as is known in the art.

### II. Structure

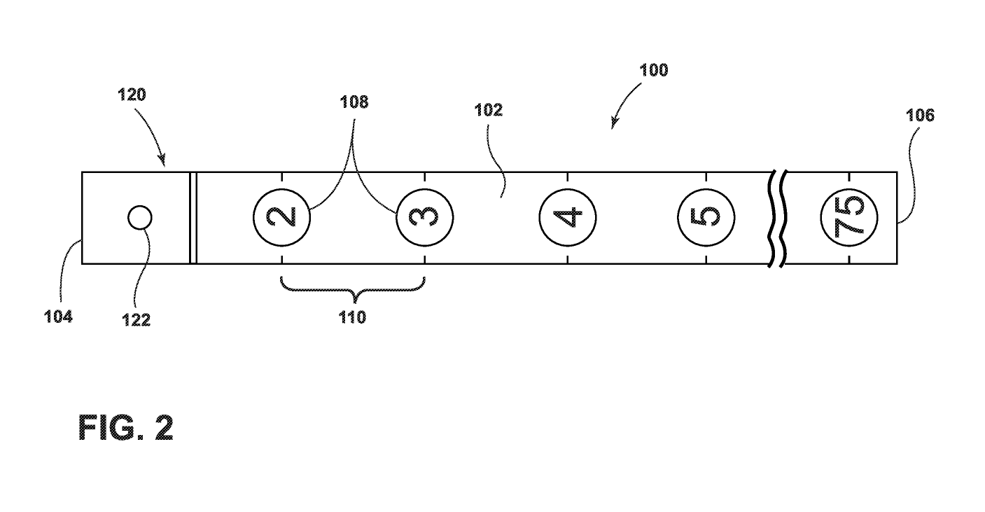

A counting tape in accordance with an embodiment of the invention is illustrated in FIG. 2 and designated 100. The counting tape 100 is configured for use with wall or floor-mounted storage systems, such as the storage system 10 of FIG. 1, that utilize rows of sequentially arranged, regularly spaced holes for assembling the components of the wall or floor-mounted storage system. While the counting tape 100 is described in the context of the floor-mounted storage system 10 of FIG. 1, it is understood that the counting tape 100 may be used within any type of storage system that utilizes rows of sequentially arranged, regularly spaced holes for assembly.

The counting tape 100 includes a tape body 102, a top end 104, and a bottom end 106. The tape body 102 includes a plurality of sequentially labeled, non-dimensional, regularly spaced markings 108 extending between the top and bottom ends 104 and 106. The spaced markings 108 include indicia that uniquely identify each marking 108, such as numbers, as illustrated, or letters (not shown). The spaced markings 108 are configured such that a space 110 between each marking 108 corresponds to a space between each of the holes 20a-d and 22a-d in the vertical panels 12a-d. The space 110 between each marking 108 may vary based on the spacing between the holes in the floor-mounted storage system for which the counting tape 100 is intended for use. For example, when the counting tape 100 is intended for use with panels having holes spaced 32 mm apart, the space 110 between each marking 108 can also be 32 mm.

The counting tape 100 optionally includes a hanging element 120 for mounting the counting tape 100 to the storage system 10 and suspending the counting tape 100 therefrom adjacent the holes 20a-d, 22a-d. As illustrated in FIG. 2, the hanging element 120 is disposed adjacent the top end 104 and precedes the spaced markings 108. The hanging element 120 may be in the form of a tab having an aperture 122 through which hardware is inserted to mount the counting tape 100 to the storage system 10. In one embodiment, the aperture 122 is sized to receive one of the pieces of hardware intended for use with the holes 20a-d and 22a-d used in assembling the storage system 10. In other embodiments, a separate piece of hardware is included for mounting the counting tape 100 which is sized on one end to be inserted into the holes 20a-d, 22a-d and sized on the other end to be inserted through the aperture 122. The aperture 122 can be pre-formed, as illustrated, or the hanging element 120 can include indicia indicating where the hanging element 120 should be punctured for inserting a piece of hardware to mount the counting tape 100.

In other embodiments, the hanging element 120 is in the form of a tab portion adjacent the top end 104. The tab portion can be used to aid a user in holding the counting tape 100 by hand adjacent to and aligned with the rows of holes 20, 22 in the vertical panel 12a. Optionally, the tab portion is configured to be more rigid than the adjacent portion of the tape body 102. For example, the tab portion may be made from a more rigid material than the adjacent tape body 102 or include a support element, such as a piece of rigid material, to aid the user in holding the counting tape 100 by hand adjacent to the vertical panel 12 for uniquely identifying a particular hole.

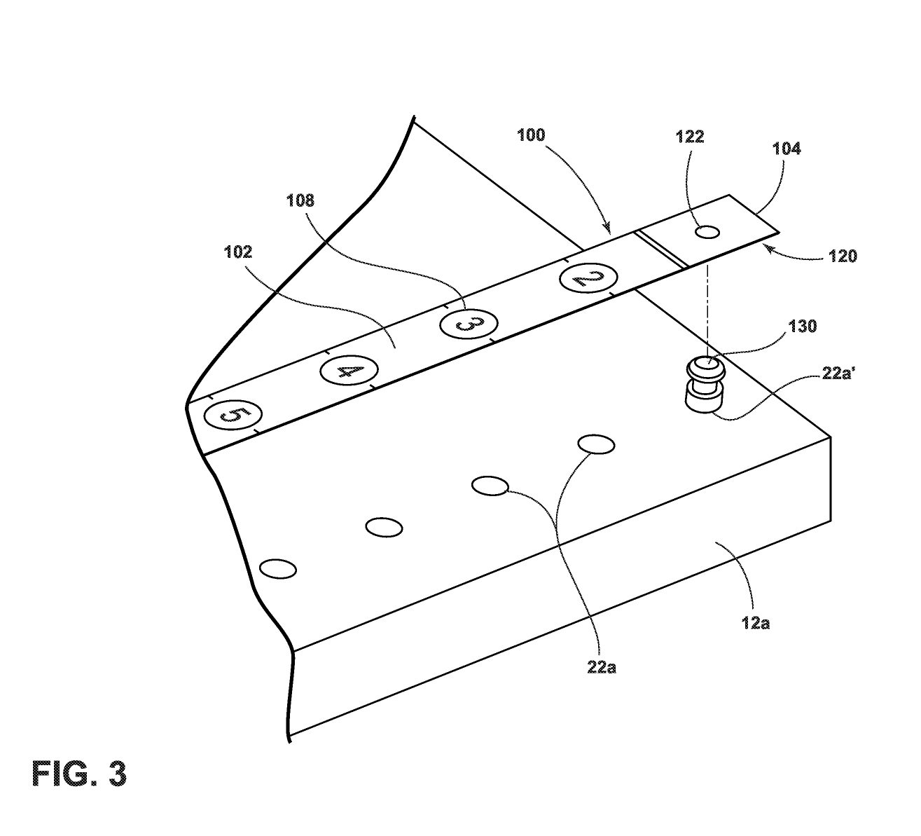

The counting tape 100 can have any desired length and any desired number of markings 108 on the tape body 102. In one embodiment, the length of the counting tape 100 corresponds to a length of the vertical panels 12a-d and the number of markings 108 correspond to the number of holes 20a-d and 22a-d in the panels 12a-d. In other embodiments, the length of the counting tape 100 and/or the number of markings 108 is less than that of the vertical panels 12a-d. Still referring to FIG. 2, the first marking 108 is replaced with the aperture 122 for mounting the counting tape 100 and the sequential labeling of the markings 108 begins at the second position. The sequential labeling of the markings 108 may continue along all or only a portion of the length of the tape body 102 such that all or only a portion of the holes 20a-d and 22a-d are uniquely identified by the counting tape 100. For example, the embodiment illustrated FIG. 2 is adapted to be mounted to a first hole 22a′ (FIG. 3) in the vertical panel 12a and enumerate holes 2 through 75.

The counting tape 100 can be made from any flexible and/or bendable material, non-limiting examples of which include paper, polymeric material, and laminates. In one example, the counting tape 100 is made from a vinyl-coated fiberglass. The counting tape 100 can be made from a flexible material such that the counting tape 100 may be rolled up or wound around a spool. In other embodiments the counting tape 100 is made from a bendable material such that the counting tape 100 may be folded up. In still another example, the counting tape 100 can include a plurality of tape body sections, each tape body section hingedly connected to an adjacent tape body section.

### II. Operation

With reference to FIGS. 3-6, an exemplary method of using the counting tape 100 to assemble the floor-mounted storage system 10 is now described. It will be understood that the counting tape 100 may be used in a similar manner to assemble other types and configurations of storage systems that utilize rows of sequentially arranged, regularly spaced holes for assembling the components. The method of use is described in the context of a single vertical panel 12a; however, the method may be repeated for each panel 12a-d during assembly of the storage system 10.

Referring now to FIG. 3, the vertical panel 12a may be laid on its back or side or stood upright for the process of inserting fasteners 130 into a desired hole in a row of holes 22a. A fastener 130 may be inserted into a first hole 22a′ in the row of holes 22a for mounting the counting tape 100 to the vertical panel 12a. The fastener 130 may be one of the fasteners used to assemble the components of the storage system 10 or a different fastener included for the purpose of mounting the counting tape 100. The counting tape 100 may be suspended from the fastener 130 by hooking the aperture 122 over the fastener 130. Alternatively, the fastener 130 may be inserted through the aperture 122 prior to inserting the fastener 130 into the first hole 22a′. While the method is described in the context of mounting the counting tape 100 to the vertical panel 12a, the counting tape 100 can be used in a similar manner by holding the counting tape 100 by hand adjacent the vertical panel 12a such that the markings 108 align with the row of holes 22a.

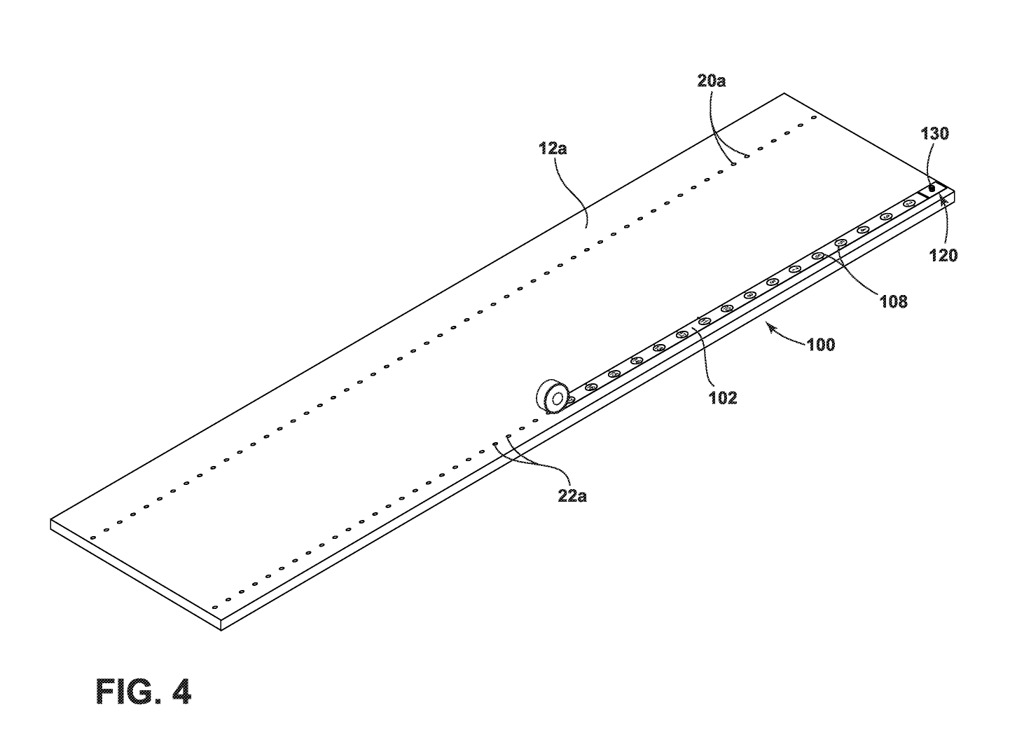

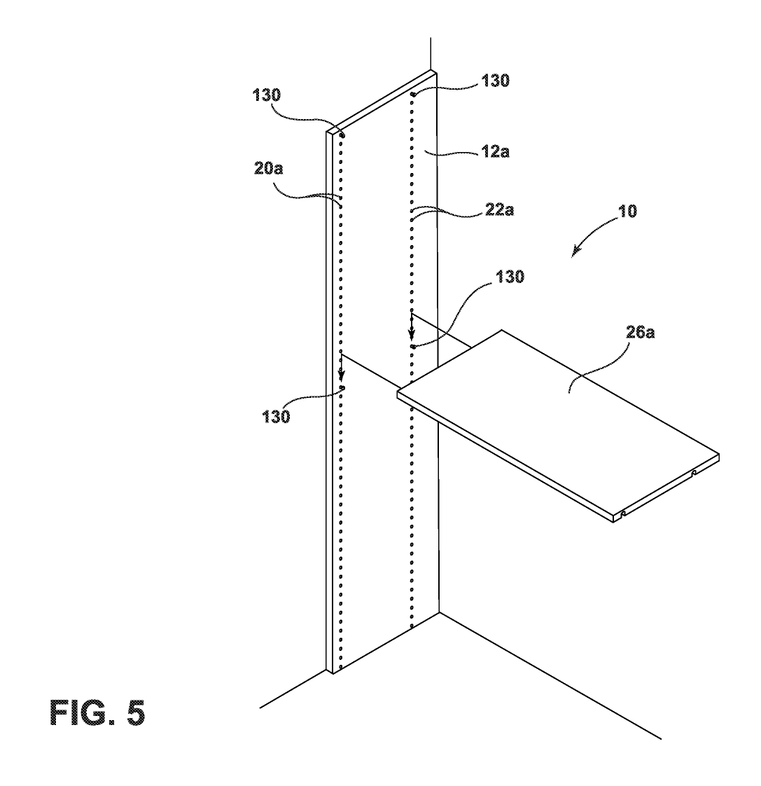

Referring now to FIG. 4, the mounted counting tape 100 can be unfurled along the length of the vertical panel 12a to uniquely identify each of the holes 22a. Each of the holes 22a is identified by the adjacent marking 108 on the tape body 102. One or more additional fasteners 130 (FIG. 5) can be inserted into a desired one of the holes 22a and the identity of the hole 22a can be noted. This process of identifying a hole 22a and inserting a fastener 130 can be repeated multiple times based on the number of fasteners 130 to be inserted.

Once the desired number of fasteners 130 has been installed in the holes 22a, the counting tape 100 can be dismounted from the row of holes 22a and mounted to the adjacent row of holes 20a in a similar manner. The fastener 130 used to mount the counting tape 100 adjacent the row of holes 22a can remain in the first hole 22a′ for subsequent use or be moved to mount the counting tape 100 adjacent the row of holes 20a. The user can use the markings 108 on the tape body 102 to identify the holes 20a that are aligned with the holes 22a into which a fastener 130 was previously inserted and insert a fastener 130 into the thus identified hole in the row of holes 20a. For example, if the user installed a fastener 130 into one of the holes 22a identified by the markings 108 as hole #35, the user can use the counting tape 100 to quickly and easily identify hole #35 in the row of holes 20a and insert a fastener 130. In this manner, the counting tape 100 enumerates the spaced holes 20a, 22a in each row such that they are easily identifiable by number.

Referring now to FIG. 5, the shelf 26a can be mounted to a pair of fasteners 130 in the row of holes 20a and 22a. The counting tape 100 is used as described above to insert the fasteners 130 into aligned holes in each of the row of holes 20a and 22a such that, once mounted, the shelf 26a rests level on the fasteners 130. The fasteners 130 may be any suitable fastener for mounting the shelf 26a.

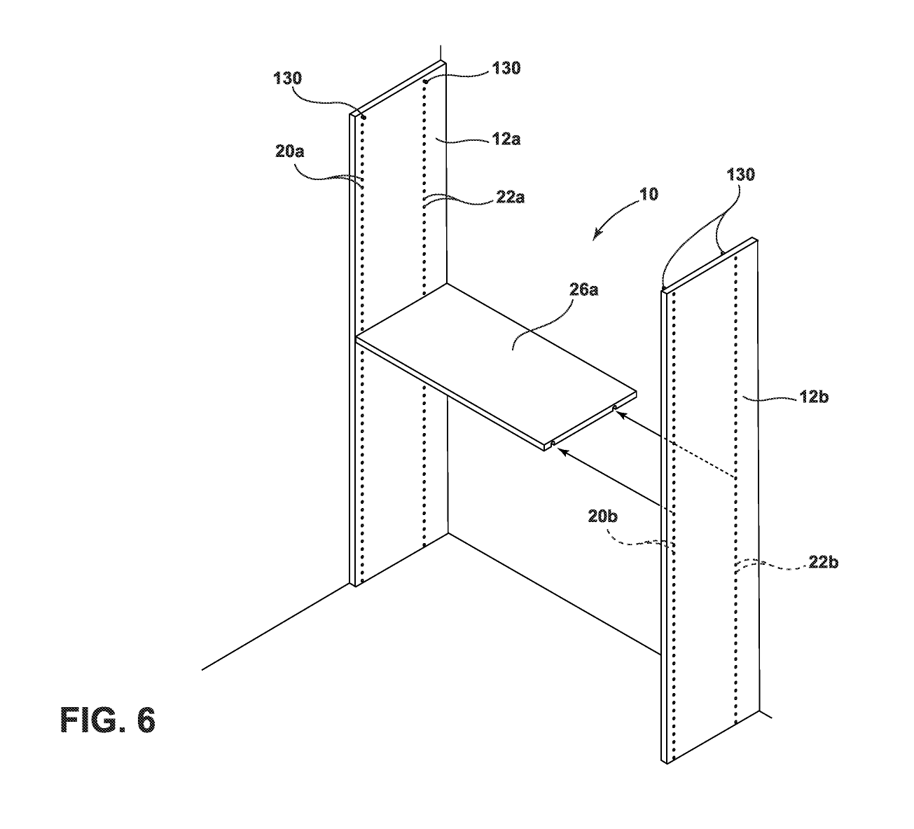

Referring now to FIG. 6, the counting tape 100 may be used to insert fasteners 130 into the vertical panel 12b into holes 20b, 22b to mount the shelf 26a between the vertical panels 12a and 12b. The counting tape 100 is used to identify which holes 20b, 22b align with the holes 20a, 22a in vertical panel 12a in a manner similar to that described above with reference to the vertical panel 12a. The counting tape 100 can be used to quickly and easily identify the hole 20b in vertical panel 12b that aligns with the hole 20a in vertical panel 12a and the hole 22b that aligns with the hole 22a. In this manner, the shelf 26a can be mounted level between the vertical panels 12a and 12b. The process for identifying holes and inserting fasteners can be used multiple times to mount various components to the storage system 10 and complete the assembly of the storage system 10.

The fasteners 130 used to mount the counting tape 100 to each panel 12a and 12b may be removed after use or used to mount an additional component to the storage system 10. For example, as illustrated in FIG. 6, the fasteners 130 inserted into the first holes in the rows of holes 20a, 22a, 20b, 22b may be used to mount the upper horizontal panel 16a (FIG. 1) between the vertical panels 12a and 12b.

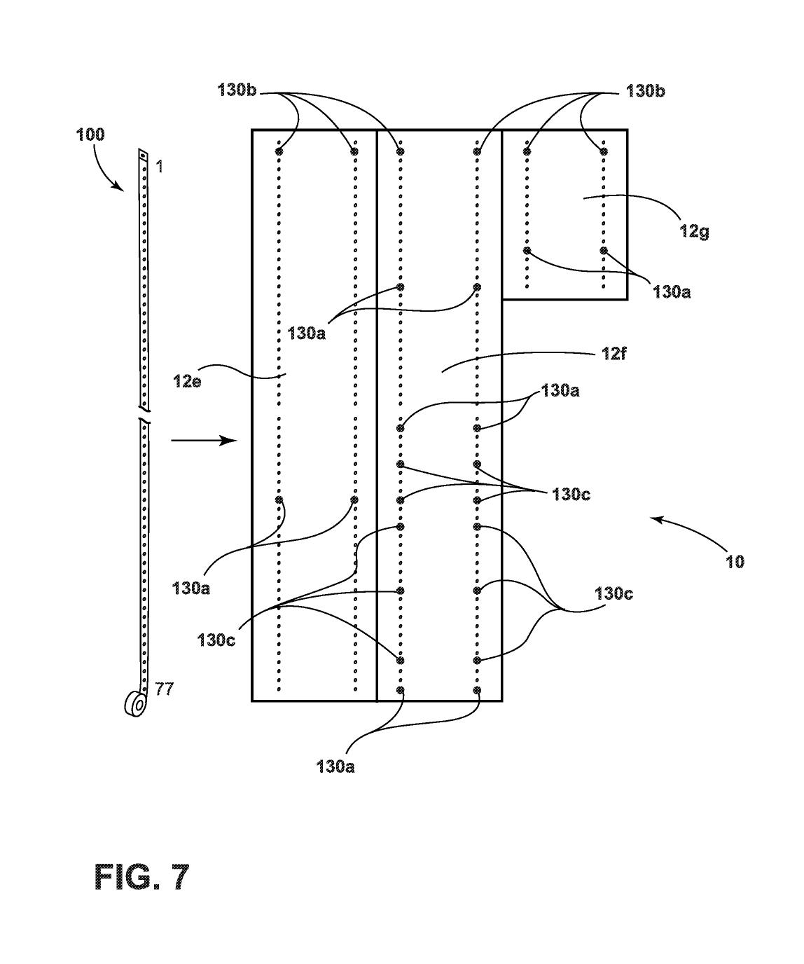

Referring now to FIG. 7, a process for using the counting tape 100 to mount different types of hardware in predetermined holes of the storage system 10 is illustrated schematically. The vertical panels 12e-12g are similar to the vertical panels 12a-d of FIG. 1 above, except for differences in the dimensions of each panel 12e-12g. The user may be provided with instructions that identify a particular piece of hardware 130a, 130b, or 130c that is to be installed into one of the holes “1” to “60” in vertical panels 12e-12f or holes “1” to “16” in vertical panel 12g.

Still referring to FIG. 7, the hardware 130a-c may be adapted to mount different components to the storage system 10. For example, hardware 130a may be adapted to mount the counting tape 100 to each panel 12e-g and/or to mount connecting horizontal panels between adjacent vertical panels 12e-g. The hardware 130b may be adapted to mount one type of component, such as a rod, while the hardware 130c is adapted to mount a different type of component, such as a drawer glide. The user may be instructed to install hardware 130a into hole number “1” in all three vertical panels 12e-g to mount the counting tape 100 and optionally mount horizontal panels between each of the vertical panels 12e-g. The different types of hardware 130a-c can be mounted to each of the panels 12e-g according to the instructions provided to the user and/or based on the user's own custom design.

The counting tape 100 can be mounted to each of the panels 12e-g in the same manner as described above for FIGS. 4-5 to easily, uniquely, and consistently identify a particular hole “1” to “60” in each panel 12e-f. The counting tape 100 can be used with panels 12e-f which include the same number of holes as the counting tape 100 is marked to identify as well as panel 12g, which includes less than “60” holes. The counting tape 100 provides the user with a tool that allows the user to quickly and easily identify which of the holes “1” to “60” a particular piece of hardware 130a-c is to be installed.

As illustrated in FIG. 7, rather than a user being required to count hundreds of holes during the assembly of the storage system 10, the counting tape 100 can be mounted to each panel 12e-g, the correct hole located using the unique markings 108 on the counting tape 100, and the appropriate piece of hardware 130a-c installed into the thus identified hole. Vertical panel 12f in particular includes several different types of hardware 130a-c in holes 1, 16, 31, 35, 39, 42, 49, 57, and 60. Inserting hardware 130a-c into the wrong hole, even if only off by a count of “1”, may prevent the next component from being properly mounted, requiring the user to start over. Moving installed hardware to a different hole can become frustrating and time consuming, especially as the complexity of the storage system 10 increases, and can sometimes damage the panel 12e-g. The counting tape 100 aids the user in aligning and installing hardware 130a-c across multiple panels 12e-g by uniquely identifying each hole on each panel. The counting tape 100 may also provide the user with confidence that the piece of hardware 130a-c has been inserted into the correct hole prior to attempting to mount the next component.

The counting tape 100 also facilitates producing instructions that are simple to communicate and easy for a user to follow and implement. The user can be provided with a visual map of the support panels 12e-g indicating which piece of hardware 130a-c should be installed into which of the holes “1” to “60” in panels 12e-f and “1” to “16” in panel 12g. The counting tape 100 can then be used by the user to identify the corresponding holes in each panel 12e-g and install the appropriate piece of hardware 130a-c.

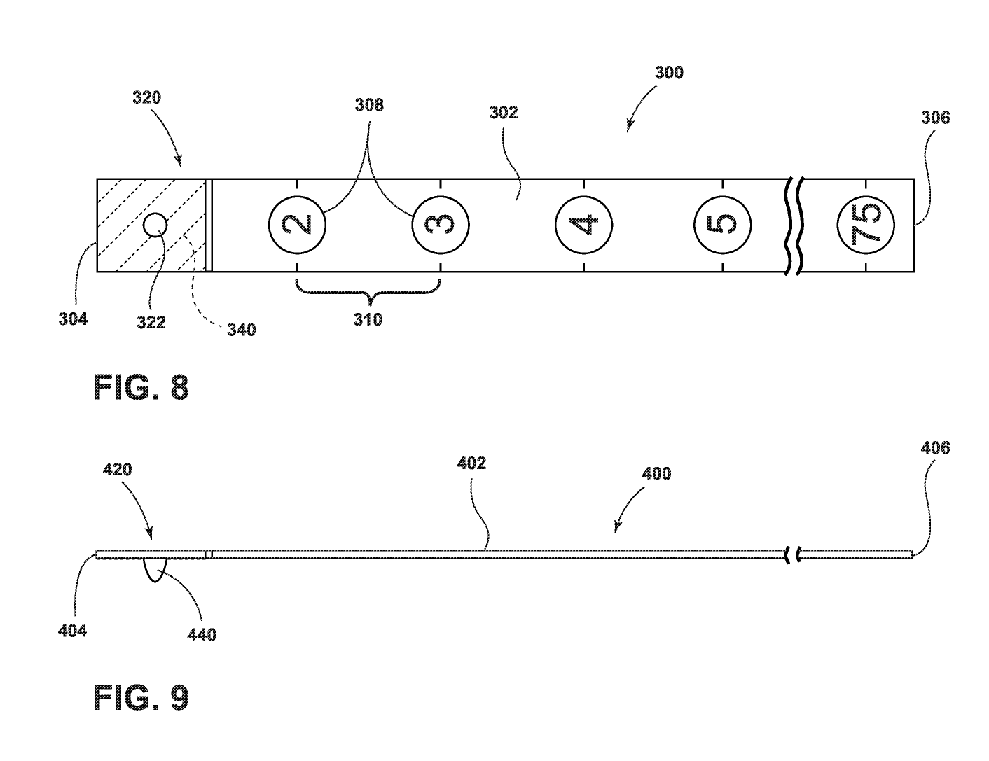

Referring now to FIG. 8, a counting tape 300 that is similar to the counting tape 100 of FIG. 2 except for the configuration of the hanging element 320 is illustrated. Therefore, elements of the counting tape 300 that are similar to those of the counting tape 100 are labeled with the prefix 300.

The hanging element 320 of FIG. 8 is in the form of an adhesive 340 applied to a tab portion of the tape body 302 preceding the markings 308 and adjacent the top end 304. In this embodiment, the hanging element 320 includes a release liner covering the adhesive 340 which is removed by the user prior to use. The adhesive 340 may releasably attach the counting tape 300 to the vertical panel 12a such that the counting tape 300 is suspended from the vertical panel 12a for identifying the holes 20a, 22a in a manner similar to that described above for FIGS. 4 and 5. The hanging element 320 may optionally include an aperture 322 that may be used to mount the counting tape 300 to the vertical panel 12 using a fastener 130 in the same manner as described above for FIGS. 4 and 5. The adhesive 340 may be used alone or in combination with the aperture 322 for mounting the counting tape 300.

FIG. 9 illustrates another embodiment, counting tape 400, which is similar to the counting tape 100 of FIG. 2 except for the configuration of the hanging element 420. Therefore, elements of the counting tape 400 that are similar to those of the counting tape 100 are labeled with the prefix 400. In this embodiment, the hanging element 420 includes a tack 440 configured to be inserted into the holes 20a, 22a of the vertical panel 12a for mounting the counting tape 400 to the vertical panel 12a. The tack 440 may be integrally formed with the tape body 402 or may be a separate component attached to the tape body 402. In this manner, the counting tape 400 may be mounted to the panel 12a for identifying the holes 20a, 22a without the use of a separate piece of hardware, such as the fastener 130.

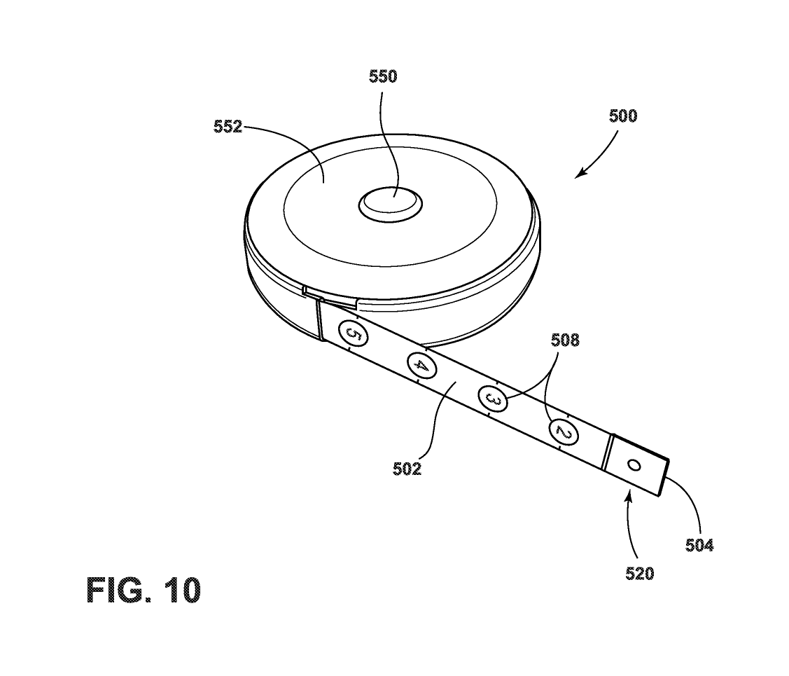

Referring now to FIG. 10, a counting tape 500 that is similar to the counting tape 100 of FIG. 2 except for the manner in which the counting tape 500 is assembled is illustrated. Therefore, elements of the counting tape 500 that are similar to those of the counting tape 100 are labeled with the prefix 500.

FIG. 10 illustrates the counting tape 500 wound around a spool 550 rotatably mounted within a housing 552 for storing and dispensing the counting tape 500. The bottom end of the tape body 502 (not shown) may be connected to the spool 550, using an adhesive or a mechanical fastener, to prevent the counting tape 500 from being separated from the spool 550 during use. The counting tape 500 can be wound around the spool 550 and selectively unwound for use identifying holes during assembly of the storage system 10. Optionally, the counting tape 500 may be re-wound around the spool 550 for storage after use. The counting tape 500 includes a hanging element 520 that may be in the form of any of the hanging elements 120, 320, or 420 described herein for mounting the counting tape 500 to the vertical panel 12a and subsequent panels during assembly of the storage system 10.

### III. Conclusion

The embodiments described herein provide for a counting tape and a method of use that facilitates assembling storage systems that utilize a plurality of pre-formed, spaced holes to assemble the components of the storage system. It can be challenging to identify aligned holes on a given panel and across multiple panels visually or by counting, particularly as the size of the panel and the number of holes within each panel increases. If hardware is inserted into the wrong hole, even a hole that is off by one, the mounted component may not be level or may not even be capable of being mounted.

The counting tape described herein may be used to quickly identify a particular hole in a panel of the storage system for inserting hardware. The counting tape can easily be moved across a single panel or multiple panels to facilitate quickly identifying holes in different rows on the same panel or on different panels. The counting tape is easy to unfurl for use and to mount to each panel to facilitate assembly of the storage system. Quickly and uniquely identifying each hole in a row of holes avoids relying on the user to count individual holes for inserting the hardware. This may save the user time and avoid the hassle of re-counting holes or moving the hardware to a different hole in an attempt to align all of the hardware as needed. Quickly and uniquely identifying each hole also facilitates consistently mounting hardware in aligned holes across multiple panels, which may decrease assembly time for the storage system, especially as the scale of the storage system increases.

The counting tape can be used when the storage system is initially assembled as well as during the lifetime of the system. The counting tape can be used to adjust the position in which various components are installed after the storage system has been initially installed. For example, a user may desire to adjust the position of a shelf upward or downward and the counting tape can be used to uniquely identify the desired aligned holes for adjustment of the storage system component.

The above description is that of a current embodiment of the invention. Various alterations and changes can be made without departing from the spirit and broader aspects of the invention as defined in the appended claims, which are to be interpreted in accordance with the principles of patent law including the doctrine of equivalents.

This disclosure is presented for illustrative purposes and should not be interpreted as an exhaustive description of all embodiments of the invention or to limit the scope of the claims to the specific elements illustrated or described in connection with these embodiments. For example, and without limitation, any individual element of the described invention may be replaced by one or more alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative.

The invention is not limited to the details of operation or to the details of construction and the arrangement of the components set forth in the above description or illustrated in the drawings. The invention may be implemented in various other embodiments and practiced or carried out in alternative ways not expressly disclosed herein. Also, the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

The disclosed embodiment includes a plurality of features that are described in concert and that might cooperatively provide a collection of benefits. The present invention is not limited to only those embodiments that include all of these features or that provide all of the stated benefits.

Any reference to claim elements in the singular, for example, using the articles “a,” “an,” “the” or “said,” is not to be construed as limiting the element to the singular.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation.

The embodiments of the invention in which an exclusive property or privilege is claimed are defined as follows:

1. A counting tape for use in assembling a wall-mounted or floor-mounted storage system, the counting tape comprising:
an elongated tape body having a first end and an opposing second end; and
a plurality of sequentially labeled, non-dimensional, regularly spaced markings on the tape body,
wherein the spaced markings correspond to sequentially arranged, regularly spaced holes in the storage system.

2. The counting tape of claim 1 further comprising a hanging element at the first end of the body to suspend the counting tape from the storage system.

3. The counting tape of claim 2 wherein the hanging element comprises an aperture adapted to receive a fastener, an adhesive, or a tack.

4. The counting tape of claim 2 wherein the hanging element comprises a tab having indicia indicating a location through which a fastener is to be inserted.

5. The counting tape of claim 2 wherein the hanging element precedes the spaced markings at the first end.

6. The counting tape of claim 1 wherein the tape body is at least one of flexible and foldable.

7. The counting tape of claim 6 wherein the tape body comprises a plurality of sections, each section hingedly connected to each adjacent section.

8. The counting tape of claim 1 wherein the spaced markings are equally spaced.

9. The counting tape of claim 8 wherein the spaced markings are spaced about 32 mm apart.

10. The counting tape of claim 1 further comprising:
a housing supporting a spool,
wherein the tape body is would around the spool and is adapted to be selectively wound and unwound from the spool.

11. A method of installing a piece of hardware in a wall-mounted or floor-mounted storage system having sequentially arranged, regularly spaced holes, the method comprising:
providing a counting tape comprising an elongated tape body having a first end and an opposing second end, the tape body including a plurality of sequentially labeled, non-dimensional, regularly spaced markings on the tape body corresponding to the spaced holes in the storage system;
supporting the counting tape adjacent the storage system by the first end such that the spaced markings on the tape body align with the spaced holes in the storage system;
selecting one of the spaced holes in the storage system; and
inserting the piece of hardware into the selected one of the spaced holes,
wherein the spaced markings enumerate the spaced holes in the storage system such that a selected one of the spaced holes is identifiable by number.

12. The method of claim 11 wherein mounting the counting tape comprises:
aligning an indicator disposed on the first end of the counting tape with a first of the spaced holes in the storage system; and
inserting a piece of hardware through the indicator into the first of the spaced holes to mount the counting tape to the storage system.

13. The method of claim 12 wherein the indicator comprises an aperture or indicia on the tape body at the first end.

14. The method of claim 13 wherein inserting a piece of hardware comprises puncturing the indicia on the tape body at the first end.

15. The method of claim 11 wherein supporting the counting tape comprises one of:
adhering the first end to the storage system adjacent a first of the spaced holes in the storage system;
tacking the first end to the storage system adjacent a first of the spaced holes in the storage system; and
holding the first end by hand up to the storage system adjacent a first of the spaced holes in the storage system.

16. The method of claim 11 wherein the providing a counting tape comprises providing a tape body that is one of folded or wound around a spool.

17. The method of claim 16, further comprising unfurling the counting tape along a length of the storage system.

18. The method of claim 11 wherein the spaced markings are equally spaced.

19. The method of claim 18 wherein the spaced markings are spaced 32 mm apart.

20. The method of claim 11 wherein supporting the counting tape comprises:
inserting a piece of hardware into a first of the spaced holes in the storage system; and
hanging the counting tape from the piece of hardware by an aperture in the first end.
